(19) United States
(12) Patent Application Publication
(10) Pub. No.: US 2014/0078408 A1
(43) Pub. Date: Mar. 20, 2014

(54) LIQUID CRYSTAL SHUTTER AND IMAGE CAPTURING APPARATUS

(71) Applicant: SAMSUNG ELECTRONICS CO., LTD., Suwon-si (KR)

(72) Inventors: Jae-kyu Shim, Ansan-si (KR); Bon-min Koo, Seoul (KR); Woo-jong Cho, Suwon-si (KR)

(21) Appl. No.: 13/912,484

(22) Filed: Jun. 7, 2013

(30) Foreign Application Priority Data
Sep. 19, 2012 (KR) 10-2012-0104005

(51) Int. Cl. G02F 1/13

(52) U.S. Cl. CPC G02F 1/1313
USPC 349/2

(57) ABSTRACT

A liquid crystal shutter configured to divide an optical path in an image capturing apparatus which captures 3D images is provided. The liquid crystal shutter includes an upper plate and a lower plate, and a liquid crystal layer disposed between the upper plate and the lower plate. Each of the upper plate and the lower plate includes a transparent plate, a polarizing film formed on an outer surface of the transparent plate, and an electrode layer formed on an inner surface of the transparent plate. A heating unit configured to heat the liquid crystal layer is disposed on any one of the electrode layer of the upper plate and the electrode layer of the lower plate.

### CROSS-REFERENCE TO RELATED APPLICATION

This application claims priority from Korean Patent Application No. 10-2012-0104005, filed on Sep. 19, 2012, in the Korean Intellectual Property Office, the disclosure of which is incorporated herein by reference in its entirety.

### BACKGROUND

1. Field

Apparatuses and methods consistent with exemplary embodiments relate to a liquid crystal shutter and an image capturing apparatus, and more particularly, to a pair of liquid crystal shutters capable of dividing one optical path into two optical paths during three-dimensional (3D) capturing, and an image capturing apparatus including the same.

2. Description of the Related Art

Techniques, which capture 3D images (stereoscopic images) and display the captured 3D images, have been already available.

One method of capturing a 3D image involves alternately capturing a left-eye image and a right-eye image. Such an capturing method is classified into a method (a 2L2S method) of using two sets of independent lenses and two image sensors, a method (a 2L1S method) of using two sets of independent lenses and one image sensor, and a method (1L1S) of using one set of lenses and one image sensor.

The 1L1S 3D capturing method is advantageous because it is easy to manufacture products in a small size as compared with other methods and because it is possible to manufacture a lens for 2D/3D in the same size as a 2D lens when an optical path dividing module, which is configured to divide an optical path into a left optical path and a right optical path, is manufactured in an open/close structure.

In the 1L1S 3D capturing method, a pair of liquid crystal (LC) shutters corresponding to the left optical path and the right optical path may be used as the optical path dividing module. The left optical path and the right optical path may be alternately shielded by the pair of liquid crystal shutters to capture a left-eye image and a right-eye image constituting a 3D image. The liquid crystal shutters alternately perform open/close operations to unshield/shield the optical paths with a considerably short time cycle during the capturing of the 3D image.

In general, since response speed of a liquid crystal layer with respect to a driving voltage is sufficiently reasonable in a room temperature environment, problems do not arise when the LC shutters perform the open/close operations to unshield/shield the optical paths with the short time cycle. However, since the response speed of the liquid crystal layer with respect to the driving voltage is considerably reduced with the increase in viscosity of the liquid crystal layer in a low temperature environment (for example, at −10° C.), The liquid crystal shutters cannot smoothly perform the open/close operations to unshield/shield the optical path when the liquid crystal shutters are driven with the short time cycle.

### SUMMARY

Various exemplary embodiments may overcome the above disadvantages and other disadvantages not described above. However, it is understood that the various exemplary embodiments are not required to overcome the disadvantages described above, and may not overcome any of the problems described above.

Various exemplary embodiments provide a liquid crystal shutter capable of smoothly performing opening/closing operations to unshield/shield an optical path for capturing a three-dimensional (3D) image in a low temperature environment, and an image capturing apparatus including the same.

According to an exemplary embodiment, a liquid crystal shutter is configured to divide an optical path in an image capturing apparatus which captures a 3D image. The liquid crystal shutter may include: an upper plate and a lower plate; and a liquid crystal layer disposed between the upper plate and the lower plate. Each of the upper plate and the lower plate may include: a transparent plate; a polarizing film formed on an outer surface of the transparent plate; and an electrode layer formed on an inner surface of the transparent plate. A heating unit configured to heat the liquid crystal layer may be disposed on any one of the electrode layer of the upper plate and the electrode layer of the lower plate.

The heating unit may be disposed to surround the liquid crystal layer.

The heating unit may include an insulating film adhered to an inner surface of the electrode layer and a heating member printed on an inner surface of the insulating film.

The heating unit may include a heating coil coated with an insulating material.

The heating unit may be disposed on only the electrode layer of the lower plate and the electrode layer of the lower plate may include: an active region corresponding to the liquid crystal layer, and a non-active region which surrounds the active region and on which the heating unit is disposed.

The lower plate may be formed to be larger than the upper plate.

The heating unit may be disposed on only the electrode layer of the upper plate and the electrode layer of the upper plate may include: an active region corresponding to the liquid crystal layer, and a non-active region which surrounds the active region and on which the heating unit is disposed.

The upper plate may be formed to be larger than the lower plate.

According to another exemplary embodiment, an image capturing apparatus that captures 3D images is provided. The image capturing apparatus may include: an image capturing device; a plurality of lenses which form an optical path between a subject to be captured and the image capturing device; and a pair of liquid crystal shutters configured to divide the optical path into two optical paths during 3D image capturing. Each of the pair of liquid crystal shutters may include: an upper plate and a lower plate; and a liquid crystal layer disposed between the upper plate and the lower plate. Each of the upper plate and the lower plate may include: a transparent plate, a polarizing film formed on an outer surface of the transparent plate, and an electrode layer formed on an inner surface of the transparent plate and configured to drive the liquid crystal layer. A heating unit configured to heat the liquid crystal layer may be disposed on any one of the electrode layer of the upper plate and the electrode layer of the lower plate.

The heating unit may include an insulating film adhered to an inner surface of the electrode layer and a heating member printed on an inner surface of the insulating film.

The heating unit may include a heating coil coated with an insulating material.

The pair of liquid crystal shutters may be disposed between two adjacent lenses among the plurality of lenses.

The pair of liquid crystal shutters may be disposed in front of the plurality of lenses.

The pair of liquid crystal shutters may be disposed in rear of the plurality of lenses.

The image capturing apparatus may be a digital camera.

Additional aspects and advantages of the exemplary embodiments will be set forth in the detailed description, will be apparent from the detailed description, or may be learned by practicing the exemplary embodiments.

### BRIEF DESCRIPTION OF THE DRAWINGS

The above and/or other aspects will be more apparent by describing in detail exemplary embodiments, with reference to the accompanying drawings, in which:

FIG. 1 is a cross-sectional view illustrating a liquid crystal shutter, according to a first exemplary embodiment;

FIG. 2 is a perspective view illustrating a lower plate provided in the liquid crystal shutter of FIG. 1;

FIG. 3 is a partially exploded perspective view of the lower plate of FIG. 2;

FIG. 4 is a view illustrating an alternative example of a heating unit disposed on the lower plate of FIG. 2;

FIG. 5 is a cross-sectional view illustrating a liquid crystal shutter, according to a second exemplary embodiment;

FIG. 6 is a cross-sectional view schematically illustrating an image capturing apparatus, according to an exemplary embodiment;

FIG. 7 is a view explaining an example of capturing a right-eye image using the image capturing apparatus of FIG. 6;

FIG. 8 is a view explaining an example of capturing a left-eye image using the image capturing apparatus of FIG. 6;

FIG. 9 is a graph that compares response speed of a liquid crystal shutter at a room temperature environment with response speed of the liquid crystal shutter at a low temperature environment, during the capturing a 3D image using a conventional image capturing apparatus; and

FIG. 10 is a graph that illustrates improvement in response speed of a liquid crystal shutter by a heating unit, during the capturing of a 3D image using an image capturing apparatus according to an exemplary embodiment.

### DETAILED DESCRIPTION

Hereinafter, exemplary embodiments will be described in more detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

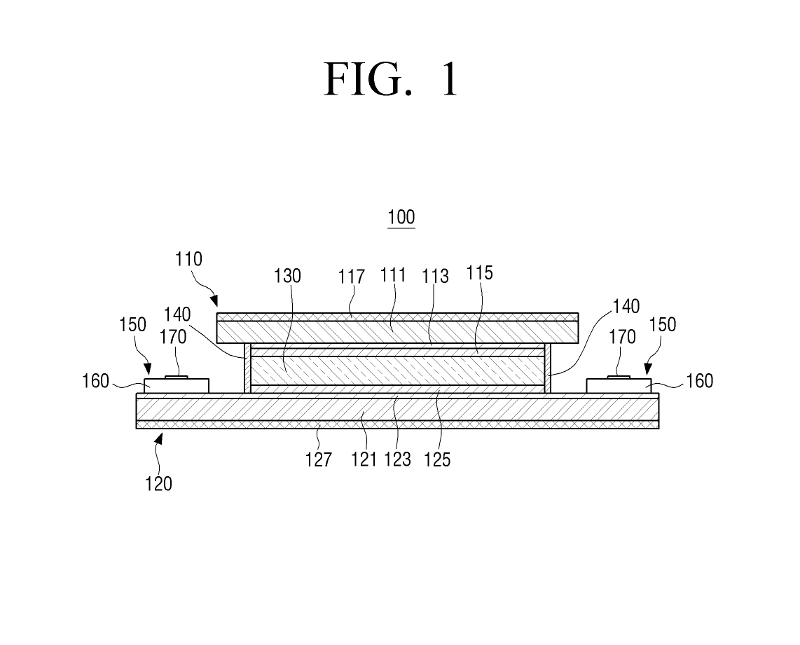

FIG. 1 is a cross-sectional view illustrating a liquid crystal shutter, according to a first exemplary embodiment.

Referring to FIG. 1, a liquid crystal shutter 100 according to the first exemplary embodiment includes an upper plate 110 and a lower plate 120 disposed in parallel with each other, a liquid crystal layer 130 disposed between the upper plate 110 and the lower plate 120, and a heating unit 150 disposed in an inner surface of the lower plate 120.

The upper plate 110 includes a rectangular-shaped first transparent plate 111, a first electrode layer 113 and a first alignment film 115 sequentially formed on an inner surface of the first transparent plate 111, and a polarizing film 117 formed on an outer surface of the first transparent plate 111. Similarly, the lower plate 120 includes a rectangular-shaped second transparent plate 121, a second electrode layer 123 and a second alignment film 125 sequentially formed on an inner surface of the second transparent plate 121, and a second polarizing film 127 formed on an outer surface of the second transparent plate 121.

The second transparent plate 121 is formed to be larger than the first transparent plate 111, and thus the lower plate 120 is larger than the upper plate 110. The first and second transparent plates 111 and 121 are manufactured of transparent glass. Alternatively, the first and second transparent plates 111 and 121 may be manufactured of transparent plastic.

The first and second electrode layers 113 and 123 are electrodes configured to apply a driving voltage (for example, 10V) to the liquid crystal layer 130. The second electrode layer 123 of the lower plate 120 may be formed to be larger than the electrode layer 113 of the upper plate 110. The first and second electrode layers 113 and 123 may be manufactured of indium thin oxide (ITO). Alternatively, the first and second electrode layers 113 and 123 may be manufactured of indium zinc oxide (IZO).

The first and second polarizing films 117 and 127 have polarization axes perpendicular to each other. The first and second alignment films 115 and 125 cause liquid crystal molecules of the liquid crystal layer 130 to be aligned in a twisted form. Therefore, the first alignment film 115 has a plurality of grooves formed in parallel with the polarization axis of the polarizing film 117, and the second alignment film 125 has a plurality of grooves formed in parallel with the polarization axis of the second polarizing film 127.

The liquid crystal layer 130 is filled between the upper plate 110 and the lower plate 120. More specifically, the liquid crystal layer 130 is disposed between the first alignment film 115 of the upper plate 110 and the second alignment film 125 of the lower plate 120, and a circumferential area of the liquid crystal layer 130 is surrounded by a sealant 140.

When a driving voltage is not applied between the first electrode layer 113 and the second electrode layer 123, the liquid crystal molecules are arranged in a twisted form by the first and second alignment films 115 and 125 so that light can penetrate the liquid crystal layer 130. A state of the liquid crystal shutter 100 when the liquid crystal layer 130 allows the light to be penetrated is called ‘white’. On the other hand, when the driving voltage (for example, 10 V) is applied between the first electrode layer 113 and the second electrode layer 123, the twisted form of the liquid crystal molecules of the liquid crystal layer 130 is released so that the light cannot penetrate the liquid crystal layer 130. A state of the liquid crystal shutter 100 when the liquid crystal layer 130 shields the light is called ‘black’.

The heating unit 150 provides heat to the liquid crystal layer 130 when the liquid crystal shutter 100 is in the low temperature environment to reduce a response time of the liquid crystal layer 130 with respect to the driving voltage.

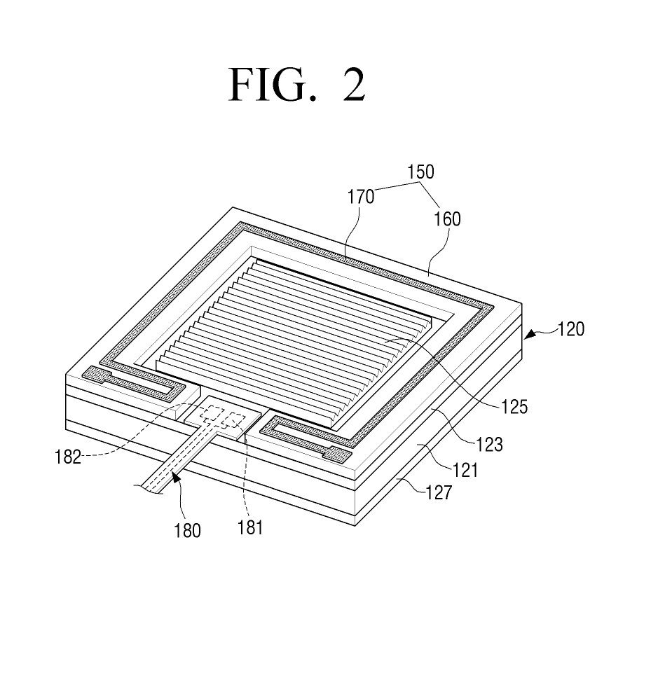

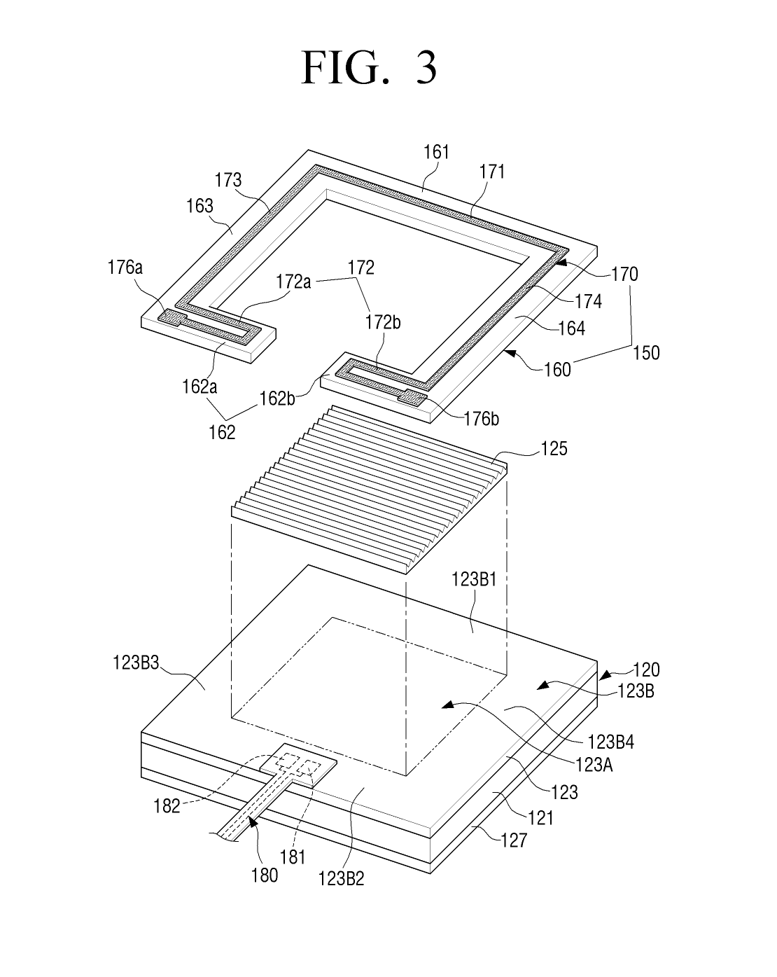

The heating unit 150 will be described in more detail with reference to FIGS. 2 and 3. FIG. 2 is a perspective view illustrating a lower plate 120 provided in the liquid crystal shutter of FIG. 1, and FIG. 3 is a partially exploded perspective view illustrating the lower plate 120 illustrated in FIG. 2.

First, the second electrode layer 123 of the lower plate 120 will be described with reference to FIG. 3. The second electrode layer 123 includes an inner region 123A on which the second alignment film 125 is placed and an outer region 123B surrounding the inner region 123A. The inner region 123A of the second electrode layer 123 is a region corresponding to the liquid crystal layer (see 130 of FIG. 1), which is disposed on the second alignment film 125, and thus may be referred to as “an active region” hereinafter. The outer region 123B of the second electrode layer 123 is a region not corresponding to the liquid crystal layer 130 and thus may be referred to as “a non-active region” hereinafter.

The active region 123A of the second electrode layer 123 has a rectangular shape corresponding to shape of the liquid crystal layer 130 and the second alignment film 125. The non-active region 123B of the second electrode layer 123 has a □-character shape and includes a first region to a fourth region 123B1, 123B2, 123B3, and 123B4. Here, the first and second regions 123B1 and 123B2 are disposed to face each other and the third and fourth regions 123B3 and 123B4 are disposed to face each other.

The heating unit 150 is disposed on an inner surface of the second electrode layer 123 and includes an insulating film 160 and a heating member 170.

The insulating film 160 is provided to prevent the heating member 170 and the second electrode layer 123 from being electrically connected to each other. Thus, the insulating film 160 may be manufactured of a non-conductive material, for example, a tri-acetyl cellulose (TAC) film.

The insulating film 160 is provided to surround the active region 123A of the second electrode layer 123. The insulating film 160 has a □-character shape with one side opened. More specifically, the insulating film 160 includes a first film portion 161 which corresponds to the first region 123B1 of the non-active region 123B and is disposed on the first region 123B1 of the non-active region 123B, a second film portion 162 which corresponds to the second region 123B2 of the non-active region 123B and is disposed on the second region 123B2 of the non-active region 123B, a third film portion 163 which corresponds to the third region 123B3 of the non-active region 123B and is disposed on the third region 123B3 of the non-active region 123B, and a fourth film portion 164 which corresponds to the fourth region 123B4 of the non-active region 123B and is disposed on the fourth region 123B4 of the non-active region 123B.

Here, the second film portion 162 may be divided into a first portion 162a and a second portion 162b to make space available for a flexible printed circuit board (FPCB) 180 to be adhered to a central portion of the second region 123B2 of the non-active region 123B. The FPCB 180 may include liquid crystal driving electrodes 181 and 182 connected to the first and second electrode layers 113 and 123, respectively, and a liquid crystal driving voltage may be applied between the first and second electrode layers 113 and 123 through the liquid crystal driving electrodes 181 and 182.

The heating member 170 generates heat for heating the liquid crystal layer 130. The heating member 170 may be manufactured of a conductive material (for example, copper (Cu)) and may have a specific resistance value (for example, 30 Ω) suitable for heating. For example, the heating member 170 may be formed by printing a Cu paste on the insulating film 160. As can be seen from FIGS. 2 and 3, the heating member 170 does not have a wire type body but a surface type body having a constant width, and thus the heating member 170 may be referred to as a kind of “surface shape heating body”.

The heating member 170 is configured to have a shape surrounding the active region 123A of the second electrode layer 123, and therefore the heating member 170 has a □-character shape with one side opened like the insulating film 160. More specifically, the heating member 170 includes a first heating portion 171 which corresponds to the first film portion 161 and is formed on the first film portion 161, a second heating portion 172 which corresponds to the second film portion 162 and is formed on the second film portion 162, a third heating portion 173 which corresponds to the third film portion 163 and is formed on the third film portion 163, and a fourth heating portion 174 which corresponds to the fourth film portion 164 and is formed on the fourth film portion 174.

Here, like the second film portion 162 which is divided into two portions 162a and 162b, the second heating portion 172 is also divided into a first portion 172a and a second portion 172b. A first heating electrode 176a and a second heating electrode 176b are formed at end portions of the first and second portions 172a and 172b, respectively. When a voltage for heating is applied between the first and second heating electrodes 176a and 176b, the conductive heating member 170 generates Joule heating.

The heating unit 150 described above is disposed on the second electrode layer 123, and the second electrode layer 123 is manufactured of ITO having good thermal conductivity. Therefore, the heat generated in the heating unit 150 can be effectively transferred to the liquid crystal layer 130 through the second electrode layer 123. On the other hand, for example, when the heating unit 150 is disposed on an outer surface of the second polarizing film 127 of the lower plate 120, the heat generated in the heating unit 150 cannot be effectively transferred to the liquid crystal layer 130 because the second polarizing film 127 and the second transparent plate 121 are disposed between the heating unit 150 and the liquid crystal layer 130.

Further, since the heating unit 150 is disposed to surround the active region 123A of the second electrode layer 123, which is covered with the liquid crystal layer 130, heating of the liquid crystal layer 130 by the heating unit 150 can be further effectively achieved in all directions.

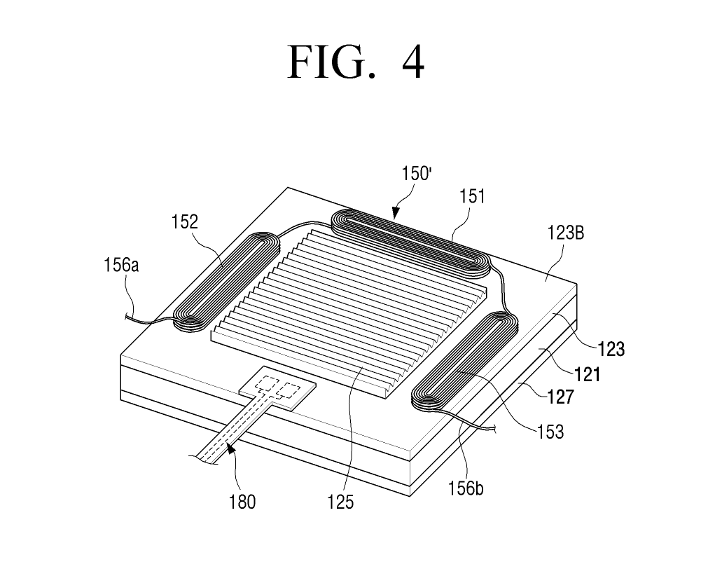

The heating unit 150 described above may be replaced with a heating unit 150′ illustrated in FIG. 4. The heating unit 150′ has a heating coil type body, and when the voltage for heating is applied between both ends 156a and 156b thereof, the heating unit 150′ generates Joule heating.

For example, the heating unit 150′ is manufactured of an enameled wire, in which a Cu wire is coated with an insulating material, and is adhered to the second electrode layer 123 by an adhesive (for example, an ultraviolet (UV) bonding adhesive).

Like the heating unit 150, so as to increase thermal transfer efficiency to the liquid crystal layer 130, the heating unit 150′ is also disposed on the non-active region 123B of the second electrode layer 123 to surround the active region (see 123A of FIG. 3) of the second electrode layer 123. The heating unit 150′ includes a first heating portion 151, a second heating portion 152, and third heating portion 153 corresponding to third sides of the active region 123A.

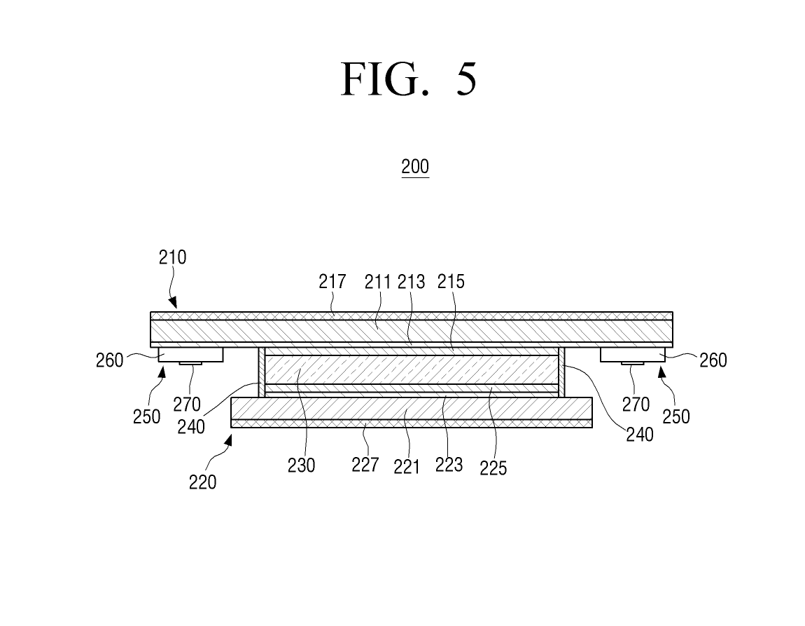

FIG. 5 is a cross-sectional view illustrating a liquid crystal shutter 200, according to a second exemplary embodiment.

Referring to FIG. 5, a liquid crystal shutter 200 according to the second exemplary embodiment includes an upper plate 210, a lower plate 220, a liquid crystal layer 230, and a heating unit 250. The reference numeral 240 denotes a sealant surrounding the liquid crystal layer 230.

Like the upper plate 110 described above, the upper plate 210 includes a first transparent plate 211, a first electrode layer 213, a first alignment film 215, and a first polarizing film 217. Like the lower plate 120 described above, the lower plate 220 includes a second transparent plate 221, a second electrode layer 223, a second alignment film 225, and a second polarizing film 227. The liquid crystal layer 230 has the same configuration as the liquid crystal layer 130 described above.

The heating unit 250 is manufactured in the same type as the heating unit (see 150 of FIG. 3) described above, and therefore the heating unit 250 includes an insulating film 260 and a conductive heating member 270 printed on one surface of the insulating film 260. The second exemplary embodiment is different from the first exemplary embodiment in that the heating unit 250 is disposed not on the second electrode layer 223 but on the first electrode layer 213. Thus, the second exemplary embodiment is different from the first exemplary embodiment in that the upper plate 210 is formed to be larger than the lower plate 220.

The heating unit 250 in the second exemplary embodiment may be also replaced with the heating unit 150′ having a heating coil type body as illustrated in FIG. 4.

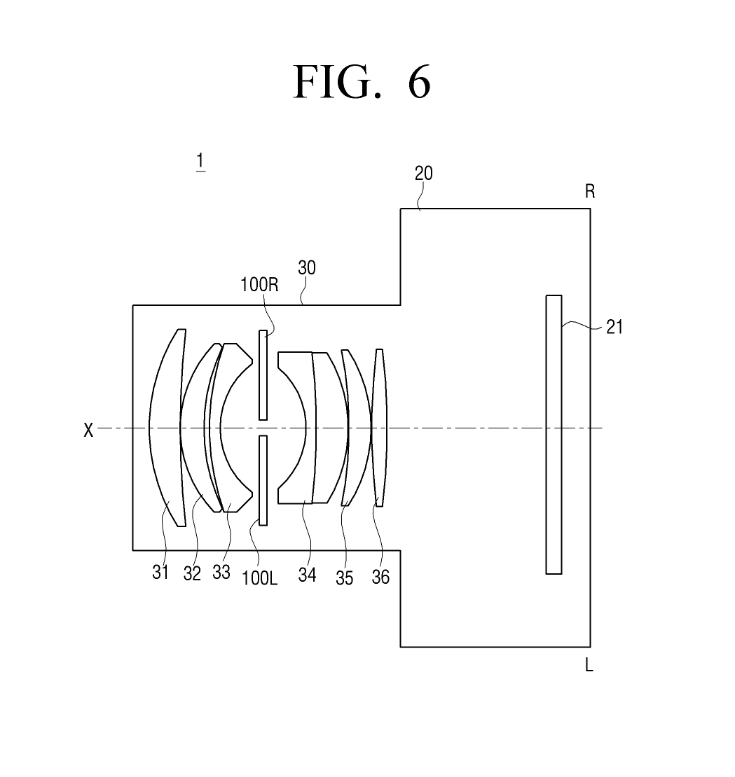

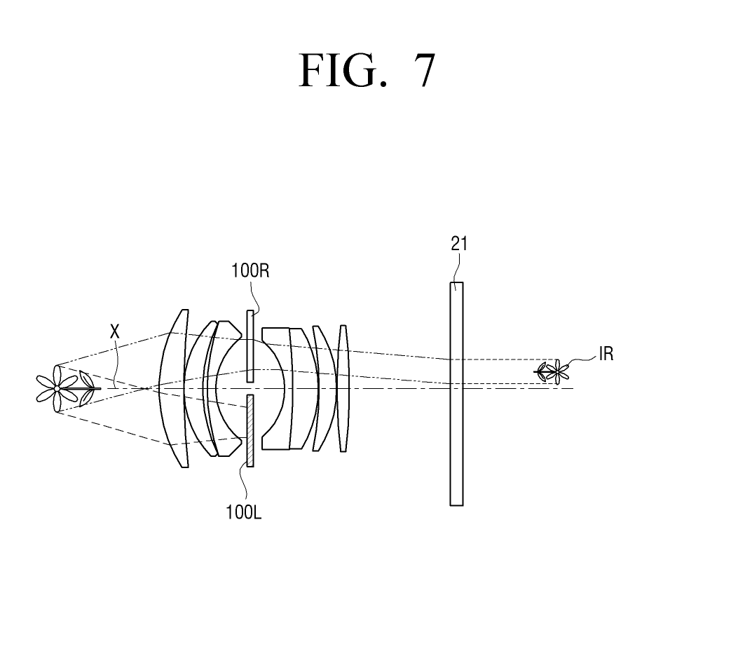

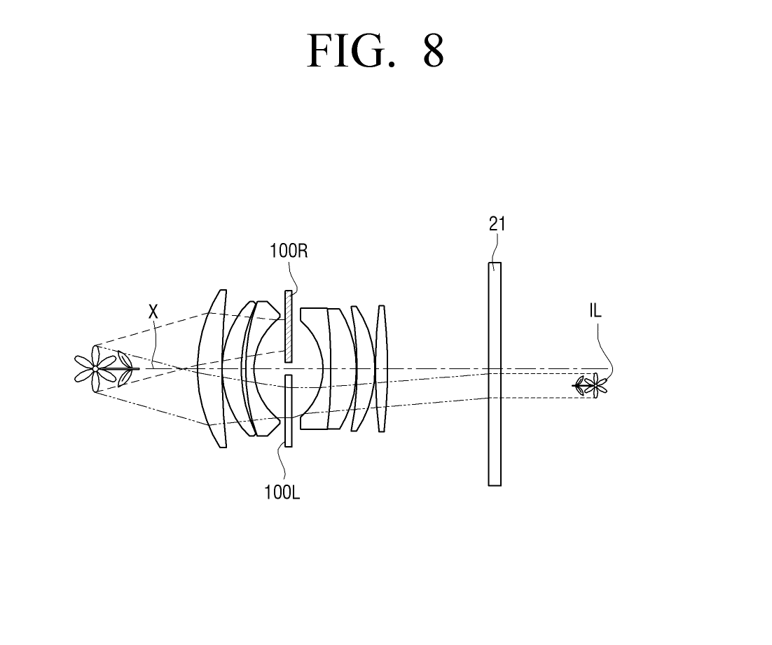

FIG. 6 is a cross-sectional view schematically illustrating an image capturing apparatus 1, according to an exemplary embodiment. FIG. 7 is a view illustrating an example of capturing a right-eye image using the image capturing apparatus 1 of FIG. 6, and FIG. 8 is a view illustrating an example of capturing a left-eye image using the image capturing apparatus 1 of FIG. 6.

Referring to FIG. 6, an image capturing apparatus 1 is a digital camera including a camera body 20 and a lens barrel 30.

The camera body 20 includes a capturing device 21 arranged to be perpendicular to an optical axis X. The capturing device 21 may include a digital image sensor such as a charge coupled device (CCD) sensor or a complementary metal oxide semiconductor (CMOS) image sensor. For clarity, other components in the camera body 20 will be omitted in FIG. 6.

The lens barrel 30 include a first lens to a sixth lens 31 to 36 arranged along the optical axis X.

An optical path dividing module configured to divide an optical path into a left optical path and a right optical path is included in the lens barrel 30, and the optical path dividing module includes a first liquid crystal shutter 100R and a second Liquid crystal shutter 100L. The liquid crystal shutters 100R and 100L perform opening/closing functions sequentially to unshield/shield the left optical path and the right optical path during the capturing of a 3D image.

In the exemplary embodiment, the liquid crystal shutters 100R and 100L have been illustrated to be disposed between the third lens 33 and the fourth lens 34, but the arrangement position of the liquid crystal shutters 100R and 100L may be differently selected in other exemplary embodiments. For example, the liquid crystal shutters 100R and 100L may be disposed between two other lenses (for example, between the fourth lens and the fifth lens), disposed in front of the plurality of lenses 31 to 36, or disposed in rear of the plurality of lenses 31 to 36. In general, the liquid crystal shutters 100R and 100L may be installed in a position where an iris is typically disposed.

Each of the liquid crystal shutters 100R and 100L consists of the liquid crystal shutter 100 of FIG. 1 according to the above-described first exemplary embodiment. Therefore, each of the liquid crystal shutters 100R and 100L includes the heating unit 150 provided on the lower plate 120. Alternatively, each of liquid crystal shutters 100R and 100L may consist of the liquid crystal shutter 200 according to the above-described second exemplary embodiment.

As illustrated in FIG. 7, when a right-eye image is captured, the right optical path is unshielded by the first liquid crystal shutter 100R and the left optical path is blocked by the second liquid crystal shutter 100L so that a right-eye image IR is obtained through the capturing device 21. That is, when the right-eye image is captured, the first liquid crystal shutter 100R is in the white state and the second liquid crystal shutter 100L is in the black state. On the other hand, as illustrated in FIG. 8, when a left-eye image is captured, the right optical path is blocked by the first liquid crystal shutter 100R and the left optical path is unshielded by the second liquid crystal shutter 100L so that a left-eye image IL is obtained by the capturing device 21. That is, when the left-eye image is captured, the first liquid crystal shutter 100R is in the black state and the second liquid crystal shutter 100L is in the white state.

The obtained right-eye image IR and left-eye image IL are synthesized to obtain a 3D image. By the way, when a 2D image is captured, the first and second liquid crystal shutters 100R and 100L are in the white state.

As described above, when the 3D image is captured, the liquid crystal shutters 100R and 100L are alternately in the white state and in the black state. At this time, the period of time in which the liquid crystal shutters 100R and 100L are consistently in the black state or in the white state is remarkably short (for example, about 15 ms). In other words, the cycle of change between the black state and the white state of the liquid crystal shutters 100R and 100L when the 3D image is captured is very short.

As described above, since the response speed of the liquid crystal layer is sufficiently reasonable in the room temperature environment with respect to the driving voltage even when the cycle is short, shielding/unshielding of the optical paths by the liquid crystal shutters 100R and 100L is normally performed. However, since the response speed of the liquid crystal layer 130 with respect to the driving voltage is considerably reduced in the low temperature environment (for example, −10° C.) due to increase in viscosity of the liquid crystal layer 130, the shielding/unshielding of the optical paths by the liquid crystal shutters 100R and 100L may be not smoothly performed.

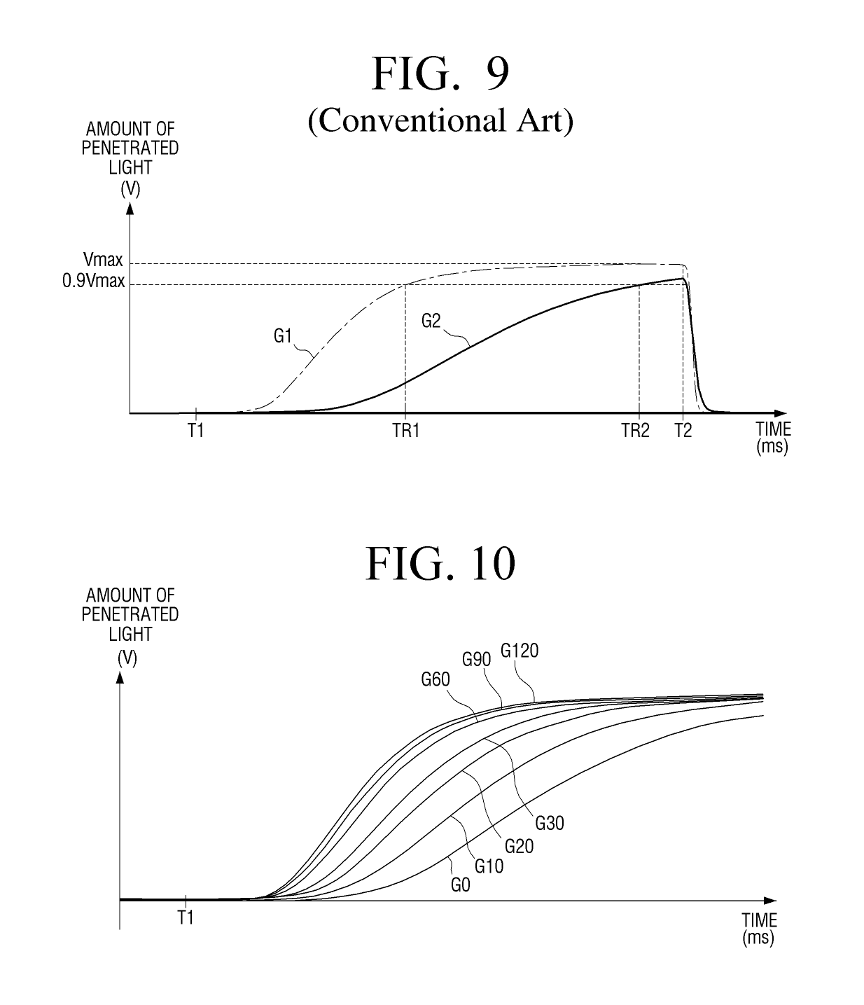

The above-described problem will be described in more detail with reference to FIG. 9. FIG. 9 is a graph that compares response speed of a liquid crystal shutter in the room temperature environment with response speed of the liquid crystal shutter in the low temperature environment, when a 3D image is captured using a conventional image capturing apparatus.

Lines G1 and G2 illustrated in FIG. 9 show amounts of light penetrating a liquid crystal shutter measured using a photodiode when a 3D image is captured using a conventional image capturing apparatus that includes the liquid crystal shutter. The line G1 shows a result obtained in the room temperature environment, and the line G2 shows a result obtained in the low temperature environment (−10° C.).

In FIG. 9, a horizontal axis indicates time (ms) and a vertical axis indicates an amount of light penetrated (voltage), which is measured using the photodiode. On the horizontal axis, T1 is a point of time when the liquid crystal shutter changes from the black state to the white state, and T2 is a point of time when the liquid crystal shutter changes from the white state to the black state. Therefore, the interval (T1-T2) between T1 and T2 is a white interval, that is, an interval in which a driving voltage is not applied to the liquid crystal shutter. On the vertical axis, Vmax indicates a maximum amount of light penetrating the liquid crystal shutter in the room temperature environment, and 0.9 Vmax indicates an amount of penetrated light corresponding to 90% of Vmax. 0.9 Vmax also corresponds to a minimum amount of penetrated light for capturing an image normally. Therefore, TR1 is a point of time when the amount of light penetrating the liquid crystal shutter in the room temperature environment reaches 0.9 Vmax, and TR2 is a point of time when the amount of light penetrating the liquid crystal shutter in the low temperature environment reaches 0.9 Vmax.

When comparing the two lines G1 and G2, it can be seen that TR2 in the low temperature environment is much greater than TR1 in the room temperature environment. This means that the response speed in the low temperature environment is slower than that in the room temperature environment, because viscosity of liquid crystal in the low temperature environment is increased. Further, it can be seen that the interval (TR2-T2) between TR2 and T2, which indicates an interval in which an image can be normally captured in the line G2, is much smaller than the interval (TR1-T2) between TR1 and T2, which indicates a period in which an image can be normally captured in the line G1. As a result, it can be seen that the amount of light penetrating the liquid crystal shutter is not sufficient in the white interval in the low temperature environment, due to the slowdown of the response speed of liquid crystal in the low temperature environment. This means that shielding/unshielding of the optical path by the liquid crystal shutter may be improperly performed in the low temperature environment.

However, by including the heating unit 150, the liquid crystal shutters 100R and 100L of the image capturing apparatus 1 according to the exemplary embodiment solve the problem caused by the low temperature environment. This will be described with reference to FIG. 10.

FIG. 10 is a graph that illustrates improvement in response speed of a liquid crystal shutter by a heating unit when a 3D image is captured using the image capturing apparatus according to the exemplary embodiment.

The lines illustrated in FIG. 10 are results obtained by measuring an amount of light penetrating the liquid crystal shutter 100R or 100L using the photodiode after the image capturing apparatus 1 has been left in the low temperature environment (−10° C.) for four hours, and then the heating unit 150 is operated for a predetermined time. Lines G0, G10, G20, G30, G60, G90, and G120 indicate the results obtained in cases in which the operating time of the heating unit 150 is 0 second, 10 seconds, 20 seconds, 30 seconds, 60 seconds, 90 seconds, and 120 seconds, respectively.

It can be understood from the lines that the response speed of the liquid crystal shutter 100R or 100L is improved by the operation of the heating unit 150. For example, when compared with the line G0 of the case in which the heating unit 150 is not operated, the line G60 of the case in which the heating unit 150 is operated for 60 seconds indicates that the response speed is remarkably improved.

Further, it can be seen from FIG. 10 that as an amount of heat provided by the heating unit 150 before the liquid crystal shutters 100R and 100L are operated is increased, the response speed of the liquid crystal shutters 100R and 100L is further improved.

From this point of view, it can be understood that since the heating unit 150 provided in each of the liquid crystal shutters 100R and 100L is directly disposed on the electrode layer 123 that has good thermal conductivity adjacent to the liquid crystal layer 130, and the heating unit 150 is disposed to surround the active region 123A of the electrode layer 123 corresponding to the liquid crystal layer 130, the heat generated by the heating unit 150 can be effectively transferred to the liquid crystal layer 130. Thus, a large improvement in the response speed of the liquid crystal shutters 100R and 100L may be effected and apparent with respect to an amount of power consumption when the heating unit 150 of the exemplary embodiment is applied.

The foregoing exemplary embodiments and advantages are merely exemplary and are not to be construed as limiting the present inventive concept. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A liquid crystal shutter configured to divide an optical path in an image capturing apparatus that captures a three-dimensional (3D) image, the liquid crystal shutter comprising:
an upper plate and a lower plate; and
a liquid crystal layer disposed between the upper plate and the lower plate,
each of the upper plate and the lower plate comprising:
a transparent plate;
a polarizing film formed on an outer surface of the transparent plate; and
an electrode layer formed on an inner surface of the transparent plate,
wherein a heating unit configured to heat the liquid crystal layer is disposed on any one of the electrode layer of the upper plate and the electrode layer of the lower plate.

2. The liquid crystal shutter as claimed in claim 1, wherein the heating unit is disposed to surround the liquid crystal layer.

3. The liquid crystal shutter as claimed in claim 1, wherein the heating unit includes:
an insulating film adhered to an inner surface of the electrode layer; and
a heating member printed on an inner surface of the insulating film.

4. The liquid crystal shutter as claimed in claim 1, wherein the heating unit comprises a heating coil coated with an insulating material.

5. The liquid crystal shutter as claimed in claim 1, wherein the heating unit is disposed on only the electrode layer of the lower plate,
wherein the electrode layer of the lower plate comprises:
an active region corresponding to the liquid crystal layer; and
a non-active region which surrounds the active region and on which the heating unit is disposed.

6. The liquid crystal shutter as claimed in claim 5, wherein the lower plate is formed to be larger than the upper plate.

7. The liquid crystal shutter as claimed in claim 1, wherein the heating unit is disposed on only the electrode layer of the upper plate,
wherein the electrode layer of the upper plate comprises:
an active region corresponding to the liquid crystal layer; and
a non-active region which surrounds the active region and on which the heating unit is disposed.

8. The liquid crystal shutter as claimed in claim 7, wherein the upper plate is formed to be larger than the lower plate.

9. An image capturing apparatus that captures three-dimensional (3D) images, the image capturing apparatus comprising:
an image capturing device;
a plurality of lenses which form an optical path between a subject to be captured and the image capturing device; and
a pair of liquid crystal shutters configured to divide the optical path into two optical paths during 3D image capturing,
wherein each of the pair of liquid crystal shutters includes:
an upper plate and a lower plate; and
a liquid crystal layer disposed between the upper plate and the lower plate,
wherein each of the upper plate and the lower plate includes:
a transparent plate;
a polarizing film formed on an outer surface of the transparent plate; and
an electrode layer formed on an inner surface of the transparent plate and configured to drive the liquid crystal layer,
wherein a heating unit configured to heat the liquid crystal layer is disposed on any one of the electrode layer of the upper plate and the electrode layer of the lower plate.

10. The image capturing apparatus as claimed in claim 9, wherein the heating unit includes:
an insulating film adhered to an inner surface of the electrode layer; and
a heating member printed on an inner surface of the insulating film.

11. The image capturing apparatus as claimed in claim 9, wherein the heating unit comprises a heating coil coated with an insulating material.

12. The image capturing apparatus as claimed in claim 9, wherein the pair of liquid crystal shutters is disposed between two adjacent lenses among the plurality of lenses.

13. The image capturing apparatus as claimed in claim 9, wherein the pair of liquid crystal shutters is disposed in front of the plurality of lenses.

14. The image capturing apparatus as claimed in claim 9, wherein the pair of liquid crystal shutters is disposed in rear of the plurality of lenses.

15. The image capturing apparatus as claimed in claim 9, wherein the image capturing apparatus is a digital camera.
